(19) United States
(12) Patent Application Publication
(10) Pub. No.: US 2008/0250858 A1
(43) Pub. Date: Oct. 16, 2008

(54) Automatic transportation device of characteristic value detection sensor of display appliance, transportation method of the same and display appliance with the same

(75) Inventor: Ik Soo Park, Seoul (KR)

Correspondence Address: LADAS & PARRY LLP, 26 WEST 61ST STREET, NEW YORK, NY, 10023, US

(73) Assignee: DOOYANG SYSTEMS INC.

(21) Appl. No.: 11/977,649

(22) Filed: Oct. 25, 2007

(30) Foreign Application Priority Data
Apr. 11, 2007 (KR) 10-2007-35500
Oct. 12, 2007 (KR) 10-2007-102867

(51) Int. Cl. G01D 11/24

(52) U.S. Cl. 73/431

(57) ABSTRACT

The automatic transportation device of a characteristic value detection sensor of a display appliance, and the transportation method of the same, and the display appliance with the same are disclosed. There are provided a measurement sensor which is positioned on a screen of a display appliance and measures a characteristic value of a display appliance; a transportation unit which transports the measurement sensor to a center portion of the screen when a characteristic value of the display appliance is measured and transports the same to one side of the display appliance when a measurement of a characteristic value of the display appliance is finished; a driving force unit which includes a spur gear engaged with the transportation unit and a driving motor connected with the spur gear; and a control unit which allows the measurement sensor to move to the center of the screen with the help of the transportation unit by operating the driving unit and allows the same to move to its original position when a measurement of a characteristic value of a display appliance is finished.

### BACKGROUND OF THE INVENTION

1. Field of the Invention

The present invention relates to an automatic transportation device of a characteristic value detection sensor of a display appliance, and a transportation method of the same, and a display appliance with the same, and in particular to an automatic transportation device of a characteristic value detection sensor of a display appliance, and a transportation method of the same, and a display appliance with the same in which a measurement sensor is mounted at one side of a screen for measuring a characteristic value of a display appliance, and the measurement sensor is transported to a center portion of a screen when a characteristic value of a display appliance is measured, and the measurement sensor is returned to its original position when a measurement is finished.

2. Description of the Background Art

A LCD monitor of a display appliance is connected with a personal computer or an office computer. However, the LCD monitor has a disadvantage in a color expression or a gradation expression as compared to a display appliance which uses a CRT (Cathode-ray Tube). The characteristic value of a display appliance is determined based on a manufacture of a display appliance. Even in case of the products by the same manufacturer, the characteristic values of the display appliances are different based on the manufacturing date.

The CRT monitor has a certain characteristic value which changes depending on an aging of a part as the time of use passes.

Each display appliance has differences in its color expression and color tone when a digital image or a certain video is displayed on a screen owing to a characteristic value difference of a display appliance. So, the users may have different feelings even in case of the same images. Each display appliance has a certain means for directly adjusting the characteristic values such as color temperature value, gamma value, contrast value, brightness value or something, so that the user may feel the unified colors. Here, a method for adjusting the characteristic values of a display appliance by directly using the above means needs to fully understand the characteristic values of a display appliance and a change of a characteristic value as each means is adjusted. In addition, the above method needs a certain level expert having much experience in a corresponding field.

In another method, an external device is used for measuring a characteristic value of a display appliance and correcting a characteristic value of a display appliance using the measured characteristic values of a display appliance.

For example, the colormeter of the U.S. Pat. No. 6,163,377 comprises rubber suction cups at a shell which has a photo detector. In a state that the colormeter is temperately attached on a screen with the help of the rubber suction cups, the characteristic values of a display appliance are measured. Namely, a construction and operation for measuring the characteristic values of a display appliance are well disclosed in the above patent.

In case of equipment used for an advanced field, a certain level characteristic value of a display appliance is provided, and a quality control of an advanced apparatus is performed based on the above level. For example, a display used in a medical equipment needs a GSDF (Grayscale Standard Display Function) in a DICOM (Digital Imaging and Communication in Medicine) Part 14. So, the display appliance used in a medical equipment is provided with a correction program for correcting the difference in characteristic values of a display appliance based on the DICOM GSDF and a measuring device of a characteristic value of a display appliance.

As shown in FIG. 1, the measuring device of a characteristic value of a display appliance is implemented in such a manner that a user fixes a sensor at a destination center portion of a screen of a display appliance, and the light source of a screen is measured. When there is a certain movement in a measuring device while measuring the characteristic values of a display appliance, since a characteristic value is unreliably measured, a certain fixing member or a support member is used for thereby preventing a certain movement of a measuring device.

For example, the monitor calibrator 10 of the U.S. Pat. No. 7,072,033 comprises suction cups 13 engaged at three supporting elements 12 which are extended from the support structure 11 as shown in FIG. 2, so that the monitor calibrator 10 is fixed on a screen.

In the above method for fixing the measuring sensor of a characteristic value of a display appliance with the help of suction cups, the measuring sensor may fall down. In case of the LCD monitor, a certain distance may not be obtained between a color filter glass of a LCD monitor and a TFT glass of a lower plate used for a signal process owing to a pressurizing operation by the suction cups, so that a certain problem may occur on a display screen.

It is the best way to additionally use an external support member for keeping the sensor closer so that an external light source is substantially blocked, not contacting with a screen of a display appliance, but it takes a long time for additionally installing a support member, and there may be space limitations. So, many inconveniences occur in the use of the system.

### SUMMARY OF THE INVENTION

Accordingly, it is an object of the present invention to provide an automatic transportation device of a characteristic value detection sensor of a display appliance, and a transportation method of the same, and a display appliance with the same which overcome the problems encountered in the conventional art.

It is another object of the present invention to provide an automatic transportation device of a characteristic value detection sensor of a display appliance, and a transportation method of the same, and a display appliance with the same in which a characteristic value sensor for measuring a characteristic value of a display appliance is automatically positioned closer to a screen of a display appliance for thereby implementing a reliable measurement of a characteristic value of a display appliance, and the characteristic value sensor returns to its original position when a measurement is finished.

To achieve the above objects, there is provided an automatic transportation device of a measurement sensor of a characteristic value of a display appliance which includes a measurement sensor which is positioned on a screen of a display appliance and measures a characteristic value of a display appliance; a transportation unit which transports the measurement sensor to a center portion of the screen when a characteristic value of the display appliance is measured and transports the same to one side of the display appliance when a measurement of a characteristic value of the display appliance is finished; a driving force unit which includes a spur gear engaged with the transportation unit and a driving motor connected with the spur gear; and a control unit which allows the measurement sensor to move to the center of the screen with the help of the transportation unit by operating the driving unit and allows the same to move to its original position when a measurement of a characteristic value of a display appliance is finished.

### BRIEF DESCRIPTION OF THE DRAWINGS

The present invention will become better understood with reference to the accompanying drawings which are given only by way of illustration and thus are not limitative of the present invention, wherein;

FIG. 1 is a picture which shows a method for measuring a characteristic value of a conventional display appliance;

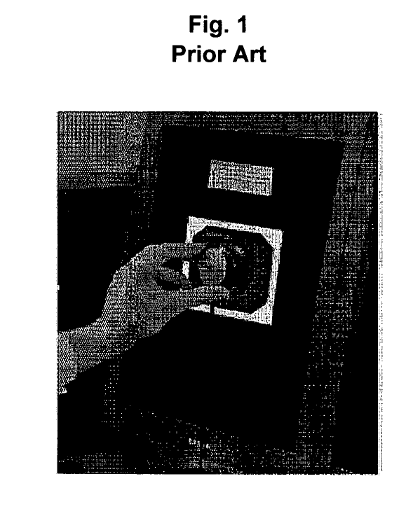

FIG. 2 is a view illustrating an apparatus for measuring a characteristic value of another conventional display appliance;

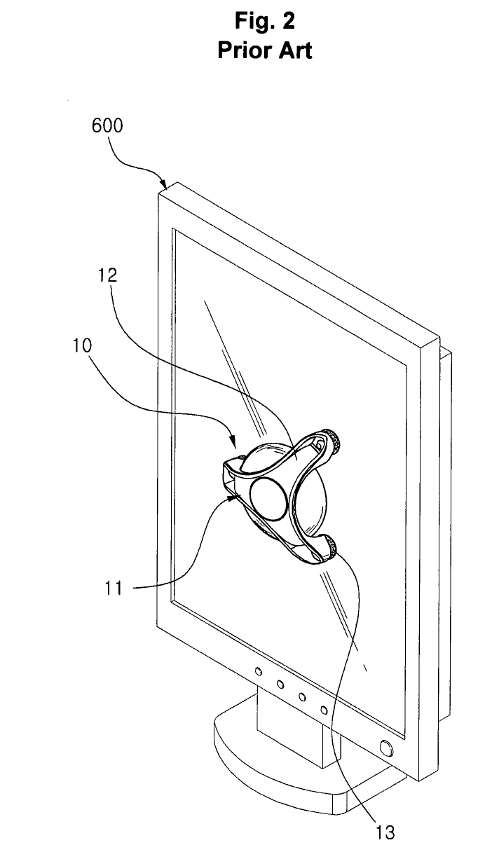

FIG. 3 is a perspective view illustrating an automatic transportation device of a measurement sensor of a characteristic value of a display appliance according to the present invention;

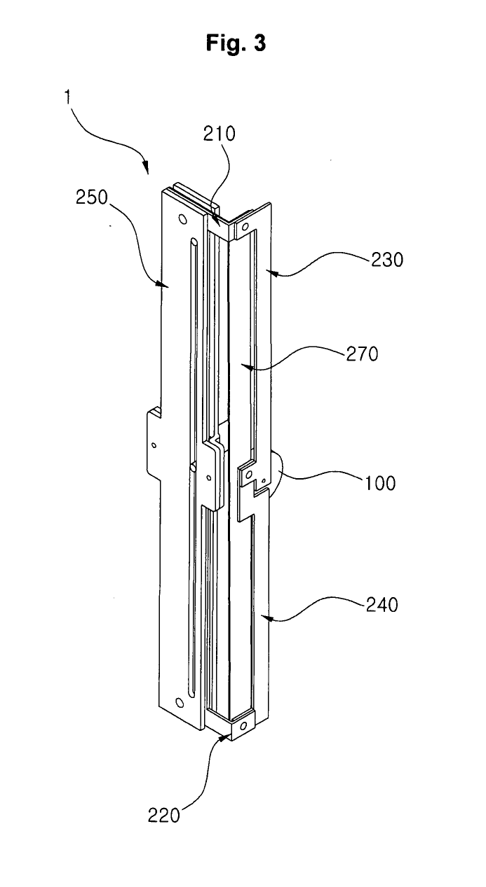

FIG. 4 is a disassembled perspective view illustrating an automatic transportation device of a measurement sensor of a characteristic value of a display appliance of FIG. 3;

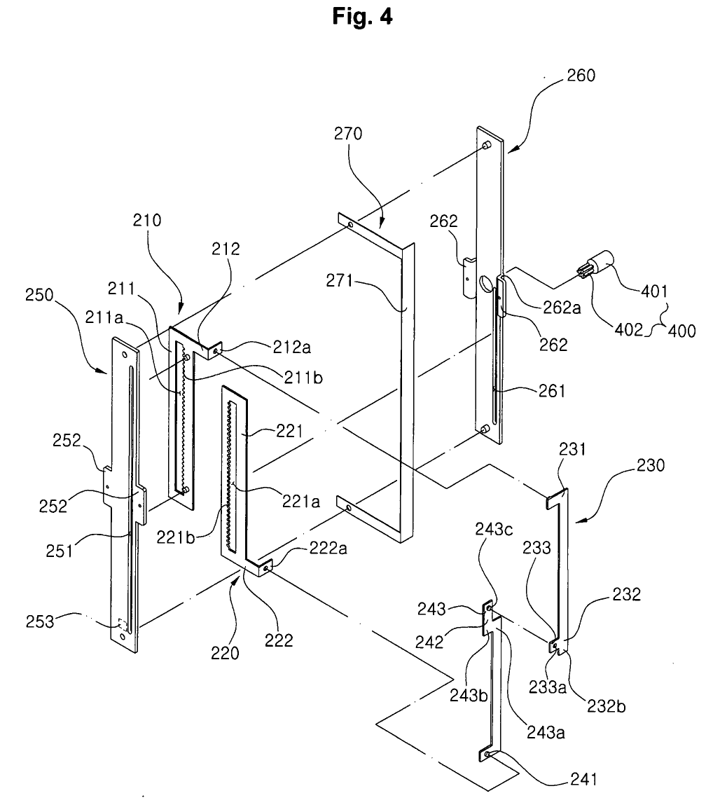

FIG. 5 is a view illustrating a use state of an automatic transportation device of a measurement sensor of a characteristic value of a display appliance of FIG. 3;

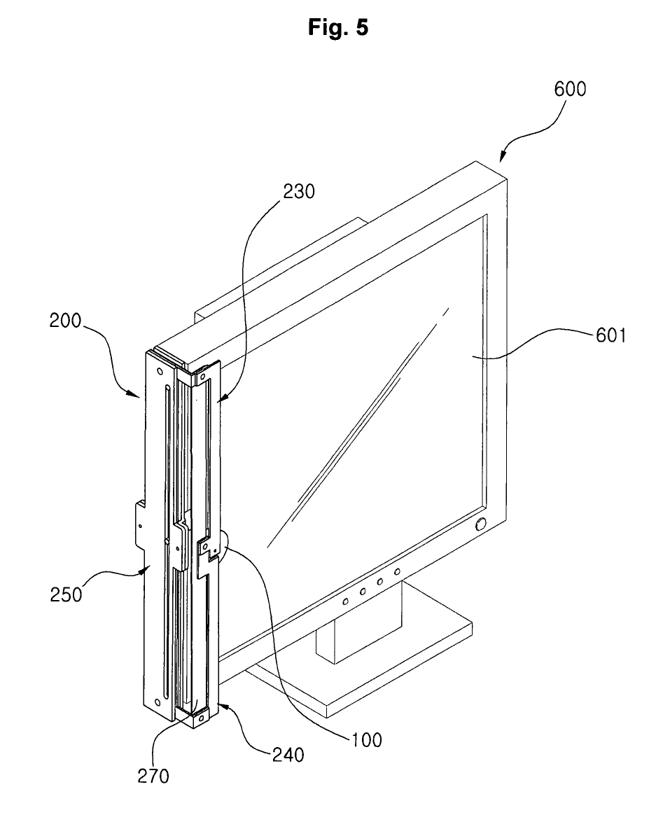

FIG. 6 is a view illustrating another use state of an automatic transportation device of a measurement sensor of a characteristic value of a display appliance of FIG. 3;

FIG. 7 is a view illustrating a use state of an automatic transportation device of a measurement sensor of a characteristic value of a display appliance according to another embodiment of the present invention;

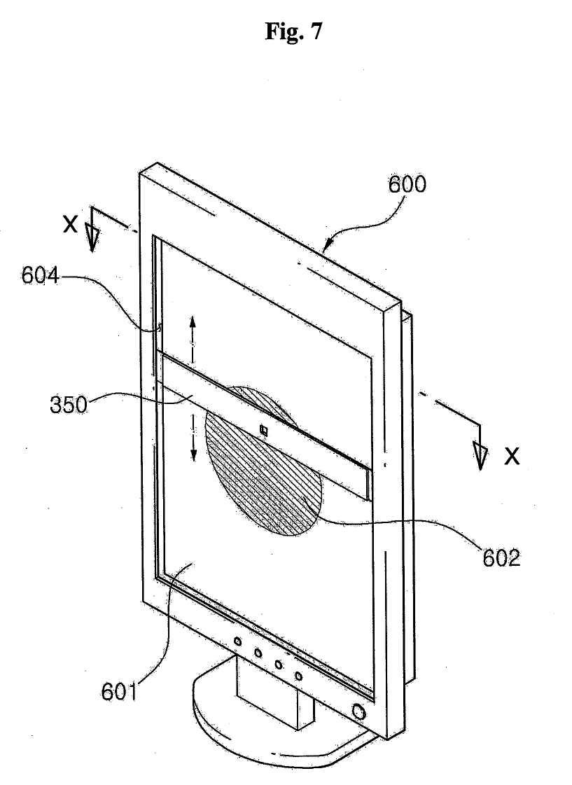

FIG. 8 is a perspective view illustrating a backside of an automatic transportation device of a measurement sensor of a characteristic value of a display appliance of FIG. 7;

FIG. 9 is a perspective view illustrating a transportation bracket engaged at an automatic transportation device of a measurement sensor of a characteristic value of a display appliance of FIG. 8;

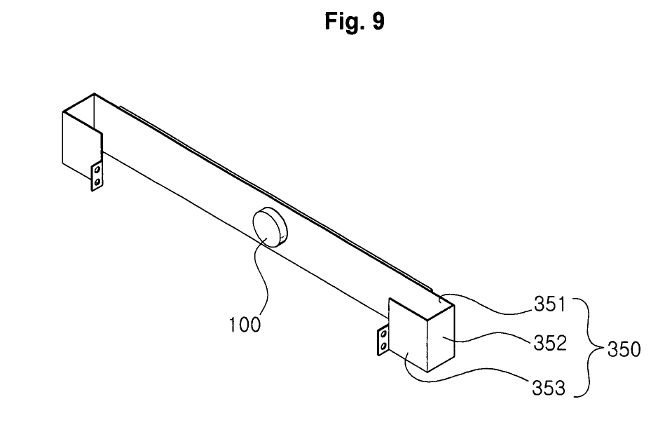

FIG. 10 is a plane view illustrating an automatic transportation device of a measurement sensor of a characteristic value of a display appliance of FIG. 8;

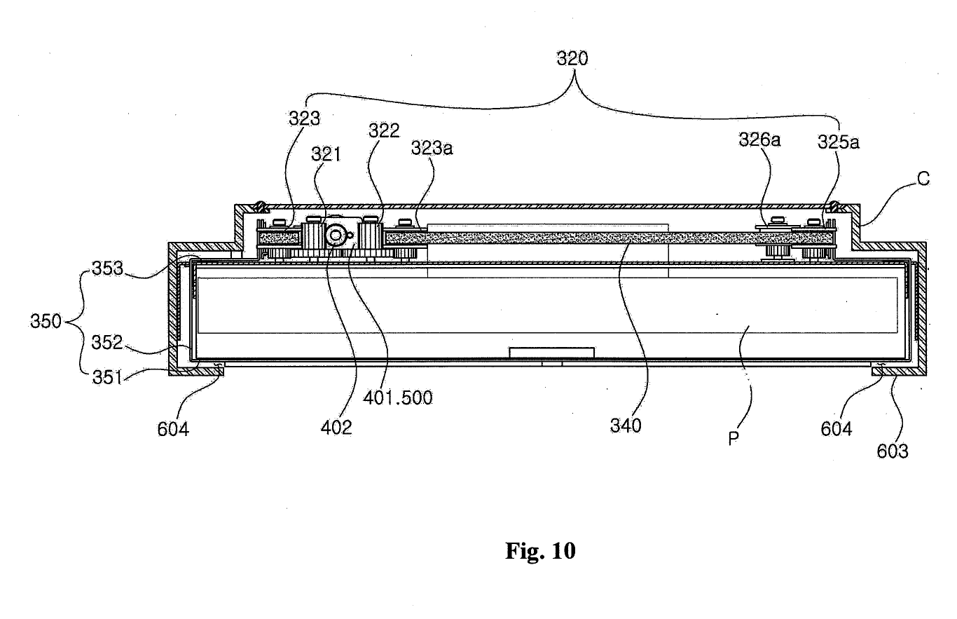

FIG. 11 is a rear view illustrating an automatic transportation device of a measurement sensor of a characteristic value of a display appliance of FIG. 8; and

FIG. 12 is a flow chart of an automatic transportation method of a measurement sensor of a characteristic value of a display appliance according to an embodiment of the present invention.

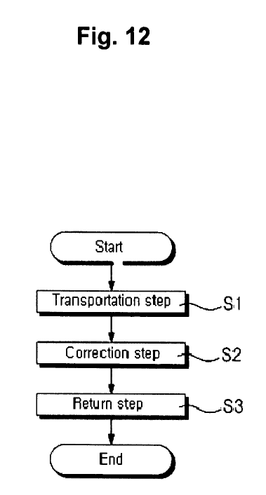

### DETAILED DESCRIPTION OF THE PREFERRED EMBODIMENTS

The construction and operation of an automatic transportation device of a measurement sensor of a characteristic value of a display appliance according to the present invention will be described with reference to the accompanying drawings.

In the descriptions, the same elements are given the same reference numerals, and the reference character P represents a schematic screen and an operation device for driving the same.

The automatic transportation device 1 of a measurement sensor of a characteristic value of a display appliance according to the present invention comprises a measurement sensor 100 for measuring a characteristic value of a display appliance, transportation units 200 and 300 for transporting the measurement sensor 100 of the display appliance to a center portion of the screen, a driving unit 400 for driving the transportation units 200 and 300, and a control unit 500 for determining an operation time and an operation direction of the driving unit 400 for thereby automatically operating the same.

The measurement sensor 100 includes a sensor for measuring a light source of the screen 601 of the display appliance. The measurement sensor 100 is positioned at one side of the display appliance 600 and is transported to a center portion of the screen 601 of the display appliance when a characteristic value of the display appliance is measured for thereby measuring a light source of the screen 601.

The transportation units 200 and 300 are used for transporting the measurement sensor 100 from one side of the display appliance to a destination point 602 near the center portion of the screen. The transportation units 200 and 300 will be described later in more detail.

The driving unit 400 includes a motor 401 which is able to change a rotation direction, and a spur gear 402 which is engaged at a rotary shaft of the motor 401. Here, as the motor 401 rotates in a certain direction, the measurement sensor 100 is transported to a center portion of the screen 601 or is transported to one side of the display appliance 600 with the help of the transportation units 200 and 300.

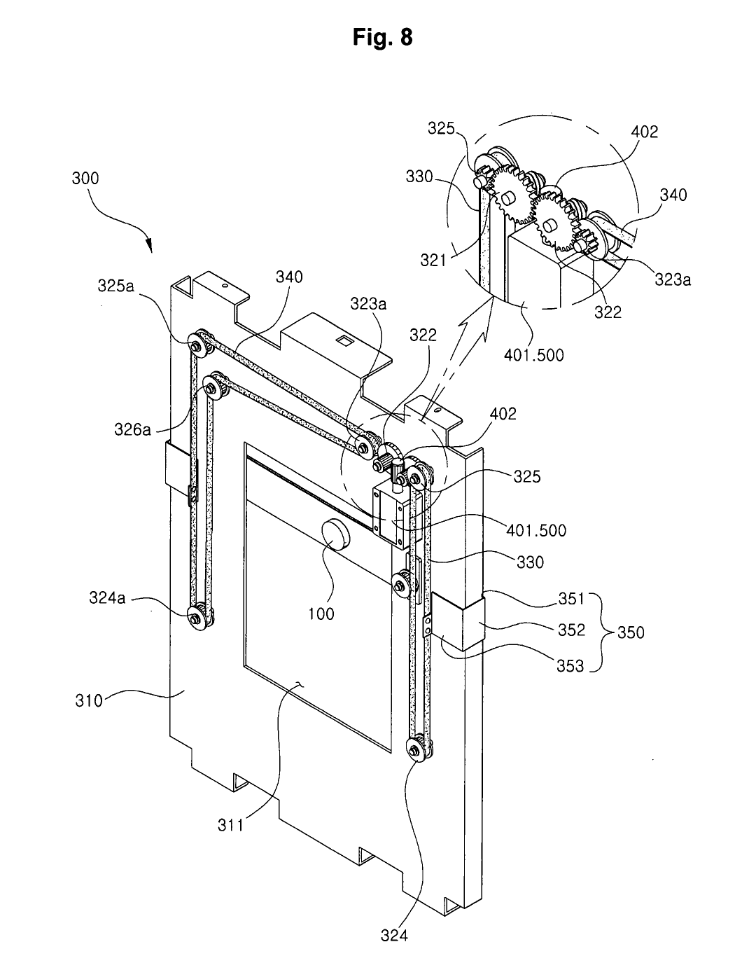

The control unit 500 detects a correction start instruction inputted from an external computer or a controller of the display appliance and allows the measurement sensor 100 to transport in the direction of the destination point 602 of the screen 601, and when a measurement of the characteristic value is finished, the measurement sensor 100 returns to its original position. As shown in FIG. 8, the control unit 500 may be integrally engaged in the interior of the motor or at an outer side of the motor.

The transportation unit 200 according to an embodiment of the present invention comprises first and second guide brackets 210 and 220, and first and second rotation brackets 230 and 240.

The first guide bracket 210 includes a first transportation piece 211, and a first engaging piece 212 extended from one side of the first transportation piece 211.

The first transportation piece 211 is formed in a plate shape having a certain length half of a side length of the display appliance 600 and includes a first transportation groove 211a in which the spur gear 402 is engaged at an inner side of the same in a direction of a lateral side of the display appliance 600. Here, a rack gear 211b is provided at one surface of a longitudinal direction of the first transportation groove 211a and is engaged with the spur gear 402. The rack gear 211b is engaged with the spur gear 402. So, in case that the first guide bracket 210 is positioned on a side surface of the display appliance 600, the first guide bracket 210 is transported from a lateral surface of the display appliance 600 in the upward and downward directions depending on a rotation direction of the spur gear 402.

The first engaging piece 212 is extended from the first transportation piece 211 in a screen direction of the display appliance with an end 212a of the same being bent toward a center portion of the screen 601. The first rotation bracket 230 is rotatably engaged at the end 212a of the first engaging piece 212.

The second guide bracket 220 comprises a second transportation piece 221, and a second engaging piece 222 and contacts with the first guide bracket 210 so that the first and second transportation pieces 211 and 221 slide with each other.

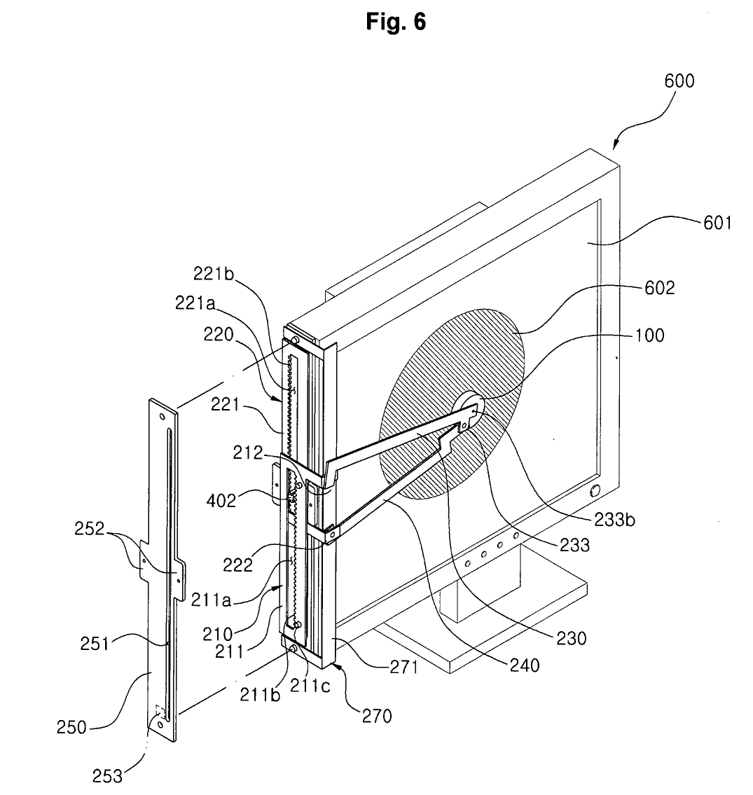

Here, a second transportation groove 221a, in which the spur gear 402 is engaged at an inner side of the same, is formed at the second transportation piece 221. The position and shape of the second transportation groove 221a is the same as the first transportation groove 211a. The rack gear 211b is formed on an inner surface in the direction opposite to the position in which the rack gear of the first transportation groove 211a is formed. As shown in FIG. 6, when the rack gear 211b of the first transportation groove 211a is formed on an inner surface far from the screen, the rack gear 221b of the second transportation groove 221a is formed on an inner surface close to the screen.

In a state that the second transportation groove 221a and the first transportation groove 211a are overlapped, the spur gear 402 sequentially passes through the first and second transportation grooves 211a and 221a and are engaged with the rack gears 211b and 221b, respectively. Namely, the rack gear 211b of the first transportation groove 211a is engaged with one surface of the spur gear 402, and the rack gear 221b of the second transportation groove 221a is engaged with the other surface of the same. So, as the spur gear 402 rotates, the first and second guide brackets 210 and 220 are transported in the opposite directions, respectively.

The second engaging piece 222 is extended from the second transportation piece 221 in the screen direction of the display appliance at the position opposite to the first engaging piece 212. The end 22a is bent in the screen direction. The bent end 22a of the second engaging piece 222 is engaged with the second rotation bracket 240 which will be described later.

One end 231 of the first rotation bracket 230 is rotatably engaged at the first engaging piece 212, and one end 241 of the second rotation bracket 240 is rotatably engaged at the second engaging piece 222. In addition, the other ends 232 and 242 of the first and second rotation brackets 230 and 240 are rotatably engaged with each other. The measurement sensor 100 is further engaged in the above construction.

The first and second rotation brackets 230 and 240 are straight parallel with the first and second guide brackets 210 and 220 in a state that the first and second guide brackets 210 and 220 are widened. In a state that the first and second guide brackets 210 and 220 are closer with each other, the engaged portion is bent in the direction of the center of the screen 601 in a protruded shape. Namely, the measurement sensor 100 of the engaged portion of the first and second rotation brackets 230 and 240 is transported toward the center of the screen 601 depending on a sliding transportation of the first and second guide brackets 210 and 220 or returns toward a lateral surface of the display appliance 600.

The first and second cover brackets 250 and 260 are engaged at the outer sides of the first and second guide brackets 210 and 220 for thereby preventing the first and second guide brackets 210 and 220 from being escaped. The transportation unit 200 is additionally installed on an outer surface of the conventional display appliance 600. The first and second cover brackets 250 and 260 restrict the transportations of the first and second guide brackets 210 and 220. So, it may be used as a member for fixing at a lateral surface of the display appliance 600.

For the above function, the first cover bracket 250 contacts with the first guide bracket 210, and the second cover bracket 260 contacts with the second guide bracket 220. The first and second cover brackets 250 and 260 are fixed with each other for thereby operating as a casing of the first and second guide brackets 210 and 220.

Here, the protrusion 211c protruded in a longitudinal direction is formed in parallel with the transportation direction at both sides of the first transportation piece 211. A first guide groove 251 is formed at the first cover bracket 250 so that the protrusion 211c slides and is engaged.

When the protrusion 211c of the first transportation piece 211 is formed at both longitudinal sides of the first transportation piece 211, since the movable scope of the protrusion 211c is limited by means of the first guide groove 251a, the length and position of the first guide groove 251 restricts the transportation distance of the first guide bracket 210.

A second guide groove 261 is formed at the second cover bracket 260, while the protrusion protruded from the second transportation piece 221 being engaged with the second guide groove. The second guide groove 261 may have a function for restricting the transportation scope of the first guide groove 251.

First and second auxiliary engaging surfaces 252 and 262 extended for an engagement of the first and second cover brackets 250 and 260 are further formed at the centers of both longitudinal sides of the first and second cover brackets 250 and 260. The second auxiliary engaging surface 262 is bent toward the first auxiliary engaging surface 252. Here, the inner space formed along the bent length as the first and second cover brackets 250 and 260 are engaged becomes a space in which the first and second guide brackets 210 and 220 slide. The bent portion 262a of the second auxiliary engaging surface 262 is caught while the first and second engaging pieces 212 and 222 move inward, so that the transportation scopes of the first and second guide brackets 210 and 220 are restricted.

The pad bracket 270 is selectively engaged at an inner surface of the first cover bracket 250 or the second cover bracket 260. The pad bracket 270 is extended toward the first and second engaging pieces 212 and 222, respectively, with an end of each piece being bent toward the screen for thereby forming a support piece 271.

The engaging position of the pad bracket 270 is determined depending on a direction that the first and second engaging pieces 212 and 222 are bent. When the first and second engaging pieces 212 and 222 are bent toward the first cover bracket 250, it is engaged at an inner side of the first cover bracket 250. When the first and second engaging pieces 212 and 222 are bent toward the second cover bracket 260, it is engaged at an inner side of the second cover bracket 260.

The support piece 271 is positioned below the bent portions of the first and second engaging pieces 212 and 222 and prevents the first and second engaging pieces 212 and 222 from being contacted with an outer surface of the display appliance 600 during the transportation of the first and second engaging pieces 212 and 222.

The first and second rotation brackets 230 and 240 are rotatably engaged with each other, and a measurement sensor 100 is engaged at the engaged portion of the first and second rotation brackets 230 and 240. The first and second rotation brackets 230 and 240 have the following engaging structure so that the engaged portions of the first and second rotation brackets 230 and 240 smoothly rotate, while stably fixing the measurement sensor 100.

The first engaging surface 233 extended toward the first guide bracket 210 is formed at a longitudinal direction of the first rotation bracket 230. A through hole 233a is formed on the first engaging surface 233 for an engagement.

The longitudinal end of the second rotation bracket 240 is first-bent (243a) toward the first guide bracket 210 for an engagement in parallel with the transportation direction of the first guide bracket 210 on the first engaging surface 233, and is second-bent (234b) toward the first engaging surface 233 for thereby forming a second engaging surface 243 which is overlapped with the first engaging surface 233.

The first and second engaging surfaces 233 and 243 is engaged as the protrusion 243c inserted into the through hole 233a of the first engaging surface 233 is formed on the second engaging surface 243 or the through hole is formed on the second engaging surface 243 for thereby obtaining a rotatable engagement using screws.

The measurement sensor 100 is stably engaged at the end 233b of the first rotation bracket 230.

The operation of the transportation unit 200 according to an embodiment of the present invention will be described.

When it is not needed to measure a characteristic value of a display appliance, the first and second engaging pieces 212 and 222 remain spaced-apart from each other. The first and second rotation brackets 230 and 240 remain widened straight or almost straight. The measurement sensor 100 fixed at the engaged portion of the first and second rotation brackets 230 and 240 is positioned at one side of the display appliance, not covering the screen 601 of the display appliance.

When it is needed to measure a characteristic value of a display appliance, the motor 401 of the driving unit 400 is driven. As the spur gear 402 rotates, the first and second guide brackets 210 and 220 are slide-transported so that the first and second engaging pieces 212 and 222 of the first and second guide brackets 210 and 220 get closer with each other with the help of the rack gears 211b and 221b engaged with the spur gear 402. As the first and second engaging pieces 212 and 222 get closer with each other, the engaged portion of the first and second rotation brackets 230 and 240 is bent, and the measurement sensor 100 fixed at the engaged portion is transported toward the center of the screen 601.

When the measurement of a characteristic value of a display appliance is finished, the motor 401 is driven to rotate in a reverse rotation direction, so that the measurement sensor 100 returns to its original position.

Here, when the first and second cover brackets 250 and 260 are provided, the transportation scope of the first and second guide brackets 210 and 220 are limited by means of the inward bent portion of the second auxiliary engaging surface 252 and the first and second guide grooves 251 and 261.

The position detection sensor 253 is fixed at the first guide groove 251 or the second guide groove 261 for detecting the movement of the first transportation piece 211 or the second transportation piece 221. It may be preferably formed of a photo sensor. Here, the position detection sensor 253 is provided at one side of the first guide groove 251 for detecting the position of the first transportation piece 211 or the second transportation piece 221 when the first and second guide brackets 210 and 220 are transported in a direction that the first and second engaging pieces 212 and 222 get closer with each other in a state that the first and second engaging pieces 212 and 222 have got substantially closer (the measurement sensor is positioned at the center of the screen).

In this case, it is possible to adjust the distance between the first and second engaging pieces 212 and 222 by using the position detection sensor 253.

The transportation unit 300 according to another embodiment of the present invention comprises a main bracket 310 positioned behind the screen 601, a driving force transmission body 320, first and second belts 330 and 340, and a transportation bracket 350.

The main bracket 310 is engaged with the driving force unit 400, and the driving force transmission body 320 in a flat plate shape.

The driving force transmission body 320 comprises a worm gear 321 engaged with the spur gear 402 of the driving force unit 400, first and second main pulleys 323 and 323a, first and second driven pulleys 324 and 324a, and a driving adjusting gear 322.

The worm gear 321 allows the rotation axis of the spur gear 402 to change vertically to the main bracket 310.

The first main pulley 323 is engaged with the worm gear 321. The direction adjusting gear 322 is disposed between the second main pulley 323a and the worm gear 321 for changing the rotation direction of the first and second main pulleys 323 and 323a to the reverse direction.

Here, a cylindrical worm gear is provided on the upper side of the worm gear 321 for changing the rotation axis with the help of an engagement with the spur gear 402. A plane gear is provided at the lower side of the same and is engaged with the teeth formed at the lower sides of the first main pulley 323 and the direction adjusting gear 322. A plane gear is provided at the lower side of the second main pulley 323a as well and is engaged with the direction adjusting gear 322. So, the worm gear 321, the direction adjusting gear 322 and the first and second main pulleys 323 and 323a are engaged as their teeth are engaged with each other. Namely, as the worm gear 321 starts rotating, the remaining gears and pulleys rotate. Here, the direction adjusting gear 322 preferably has the same circumference as the worm gear 321 so that the angular speeds of the first and second main pulleys 323 and 323a become same. The first and second driven pulleys 324 and 324a are spaced-apart from the first and second main pulleys 323 and 323a and are opposite to each other at both sides of the main bracket 310.

The first and second belts 330 and 340 are connected between the first and second main pulleys 323 and 323a and the first driven pulleys 324 and 324a. The first belt 330 is connected between the first main pulley 322 and the first driven pulley 324 spaced apart from the first main pulley 323. So, as the worm gear 321 rotates, the first belt 330 is driven. The second belt 340 is connected between the second main pulley 323a and the second driven pulley 324a spaced apart from the second main pulley 323a. So, as the worm gear 321 rotates, the second belt 340 is driven in the opposite direction as compared to the first belt 330. At this time, the first and second main pulleys 323a and 323a and the first and second driven pulleys 324 and 324a connected via the first and second belts 330 and 340 are installed in parallel at both sides of the main bracket 310, so that the first and second belts 330 and 340 are properly driven.

The construction of the first and second driven pulleys 324 and 324a may be implemented as follows.

In one construction, when the first main pulley 323 is installed at a corner of the main bracket 310, one end of the first belt 330 is connected to the first main pulley 323, and the other end of the same is connected to the first driven pulley 324. At this time, the first driven pulley 324 is installed in parallel with the first main pulley 323 so that the outer side of the first belt 330 is positioned in parallel with respect to the side surface of the main bracket 310.

In another construction, when the second main pulley 323a cannot be installed at a corner, there is further provided a second auxiliary pulley 325a installed near a corner of the main bracket 310 so that the second belt 340 rotates at a parallel position with respect to the side surface of the main bracket 310.

The outer side of the second belt 340 is supported on the second auxiliary pulley 325a, and the second belt 340 passing through the second auxiliary pulley 325a and the second driven pulley 324a is parallel with the side surface of the main bracket 310.

A fourth auxiliary pulley 326a may be further installed at an inner side of the second auxiliary pulley 325a so as to obtain a certain space for allowing the second belt connected between the second main pulley 323a and the second driven pulley 324a to pass through. The inner side of the second belt 340 may be supported on the fourth auxiliary pulley 326a. So, there is provided a space 311 in the above manner for thereby installing a screen driver in the space. The above space may be used as an installation space of a radiator of the screen driver.

The use of each auxiliary pulley is determined depending on an installation position of the driving force unit 400. As shown in FIG. 8, when the driving force unit 400 is installed near a corner of the main bracket 310, the first belt 330 is directly connected with the first main pulley 323 and the first driven pulley 324, and the second belt 340 is connected with the second main pulley 323a and the second driven pulley 324a. The belt may be further connected via the second and fourth auxiliary pulleys 325a and 326a.

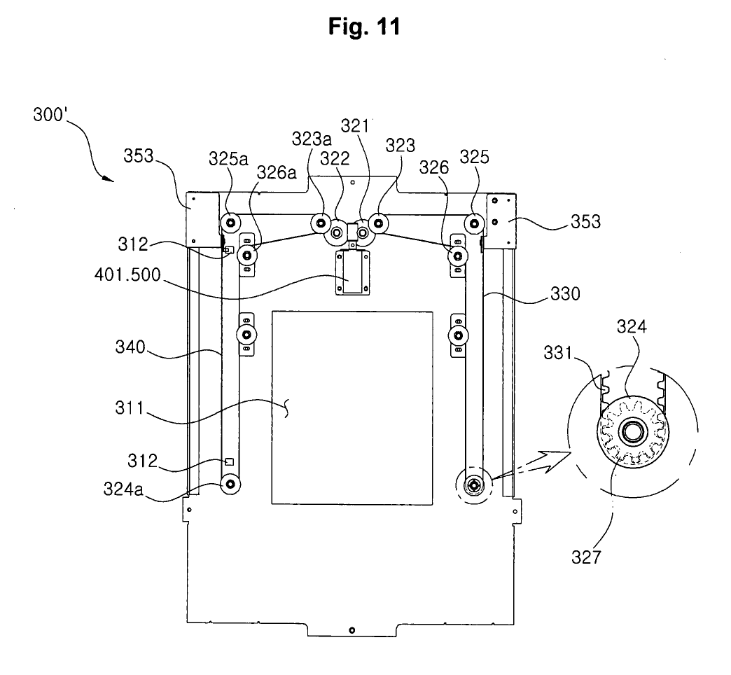

As shown in FIG. 11, when the driving force unit 400 is installed at a center portion of one side of the main bracket 310, the intermediate portions of the first and second belts 330 and 340 may be supported on the first and second auxiliary pulleys 325 and 325a and the third and fourth auxiliary pulleys 326 and 326a installed at the inner side, while being connected with the first and second main pulleys 323 and 323a and the first and second driven pulleys 324 and 324a.

The transportation bracket 350 comprises a front piece 351 in which the measurement sensor 100 is engaged at an inner center portion, a side piece 352 which is bent and extended from both longitudinal ends of the front piece 351 and covers a side portion of the screen 601 and the main bracket 310, and a rear piece 353 which is bent and extended from the side piece 352 and is connected with the first and second belts 330 and 340. The transportation bracket 350 is schematically formed in a C shape.

The side piece 352 slides in a state that the measurement sensor 100 fixed at the front piece 351 is spaced apart from the screen 601 and has a certain length corresponding to a thickness for covering the screen and the driver of the screen. So, the transportation bracket 350 covers the screen and the driver of the screen and transports the measurement sensor 100 in a state that it is spaced apart from the screen 601.

The gear teeth 327 are formed on the outer surfaces of the first and second main pulleys 323 and 323a or the first and second driven pulleys 324 and 324a or the first through fourth auxiliary pulleys 325, 325a, 326 and 326a so that an uniform transportation of the transportation bracket 350 is obtained as the first and second belts 330 and 340 rotate. Teeth 331 engaging with the above gear teeth are formed on the inner sides of the first and second belts 330 and 340.

The first and second belts 330 and 340 properly drive without slippery with respect to the rotations of the first and second main pulleys 323 and 323a or the first and second driven pulleys 324 and 324a or the first through fourth auxiliary pulleys 325, 325a, 326 and 326a.

Here, the first and second belts may be made of a metallic wires such as a steel wire. In this case, it is possible to reduce the height of each pulley, so that each corner portion of a display appliance may be made thinner.

The position detection sensor 312 for detecting the position of the rear piece 353 may be provided on a moving path of the rear piece 353 of the main bracket 310. Here, the position detection sensor 312 may be provided at a portion corresponding to the destination point 602 of the screen 601 and a rear piece 353 provided at a portion near the side surface of the display appliance 600. So, it is possible to reliably detect whether the measurement sensor 100 is positioned at the center of the screen 601 or at a side portion of the display appliance 600 with the help of a signal of the position detection sensor 312. At this time, the position detection sensor 312 may be formed of a photo sensor.

The display appliance 600 comprises a measurement sensor of a characteristic value of a display appliance having the transportation unit 300. A space groove 604 is formed between an edge of a screen and a rim of a casing C of a display appliance for a reliable transportation of the transportation bracket 350 so that the front piece 351 and the side piece 352 can slide. When it is not needed to measure the characteristic value of a display appliance, the transportation bracket 350 may be accommodated in the space groove 604 formed at one side of the display appliance.

The operation of the transportation unit 300 according to another embodiment of the present invention will be described.

When it is not needed to measure the characteristic value of a display appliance, the transportation bracket 350 is positioned at one side of the main bracket 310. At this time, the transportation bracket 350 is accommodated in the rim which covers the edge of the screen 601 for thereby enhancing an outer look of the system when viewing from outside.

When it is needed to measure the characteristic value of the display appliance, the motor 401 of the driving unit 400 starts rotating. So, the spur gear 402 rotates. As the driving force transmission body 320 rotates, the first and second belts 330 and 340 rotate in reverse directions. The transportation bracket 350 is transported toward the center of the screen 601 with the help of the rear piece 353 connected with the first and second belts 330 and 340. When viewing from the outside of the display appliance 600, it is possible to see that the front side of the transportation bracket 350 is transported from the rim 603 of one side of the display appliance 600.

When the measurement of the characteristic value of the display appliance is finished, the transportation bracket 350 returns to its original position as the motor 401 of the driving force unit 400 rotates in the reverse direction.

At this time, in case that the position detection sensor 312 is provided, when the transportation bracket 350 is positioned near the screen 601, the position of the rear piece 353 is detected, and the operation of the driving force unit 400 is stopped. When the transportation bracket 350 returns to its original position, the position of the rear piece 353 is detected at the time when the transportation bracket 350 is substantially accommodated for thereby stopping the operation of the driving force unit 400.

The automatic transportation method of the measurement sensor of a characteristic value of the display appliance according to the present invention will be described.

There is provided the transportation method of a measurement sensor using an automatic transportation device of a measurement sensor of a characteristic value of a display appliance which includes a measurement sensor 100, transportation units 200 and 300, a driving force unit 400 and a control unit 500, which comprises a transportation step in which the driving force unit 400 operates in accordance with a user's measurement start instruction, and the measurement sensor 100 is transported near a center of the screen of the display appliance 600; a correction step in which a characteristic value of the display appliance is measured with the help of the measurement sensor 100, and the screen is adjusted by using the measured characteristic value of the display appliance; and a return step in which the measurement sensor 100 returns to its original position by operating the driving force unit 400 after the screen adjustment is finished.

In the transportation step, when a measurement start instruction is inputted from an input member, the control unit 500 detects the input and allows the driving force unit 400 to operate for transporting the measurement sensor 100 engaged at the transportation units 200 and 300 toward the center of the screen in a step S1.

When the measurement sensor 100 is positioned at the center of the screen, the motor 401 may be stopped as follows.

The control unit 500 may allow the spur gear 402 to rotate by a certain revolution previously set depending on the capabilities of the spur gear 402 engaged with the transportation units 200 and 300 and the rack gears 211b and 221b engaged with the same.

When a rotation load occurs in the motor 401 as the first and second engaging pieces 212 and 222 are caught by the second auxiliary engaging surface 262, the control unit 500 detects the rotation load by means of the structural drive limitations of the transportation units 200 and 300 for thereby disconnecting the power of the driving force unit 400.

When the position detection sensors 253 and 312 detect the position of the first transportation piece 211 or the second transportation piece 221 or detect the position of the rear piece 353 of the transportation bracket 350 and generates a certain signal, the control unit 500 receives the signal and disconnects the power of the driving force unit 400.

In the correction step, the characteristic value of a display appliance is corrected based on the program by using a characteristic value of a display appliance measured by means of the measurement sensor in a step S2.

In the return step, the control unit 500 detects a state that a measurement of a characteristic value of a display appliance is finished, in accordance with a signal from the measurement sensor 100 or a corresponding program, the control unit 500 allows the motor of the transportation step to rotate in a reverse direction, so that the measurement sensor 100 returns to its original position in a step S3.

Here, as a method for stopping the operation of the motor 401 when the measurement sensor 100 was returned to its original position, a certain method may be selected from the methods such as a method for using the previously set revolution of the spur gear 402, a method for using a rotation load which occurs as the lengths of the first and second transportation grooves 211a and 221a are limited, and a method for using a position detection sensor installed at the first transportation groove 211a or a position detection sensor installed at a corner of the main bracket 310.

As described above, the automatic transportation device of a characteristic value detection sensor of a display appliance, and the transportation method of the same, and the display appliance with the same of the present invention have the following advantages.

In the present invention, it is possible to measure a reliable characteristic value of a display appliance unless a user directly installs a certain support member when a characteristic value of a display appliance is measured by closely contacting a characteristic value sensor with the screen, so that a simple and easier measurement of the characteristic value of the display appliance is implemented.

When a user inputs a measurement start instruction for measuring a characteristic value of a display appliance, the measurement sensor is automatically driven for measuring a characteristic value of the display appliance, and when the measurement is finished, the measurement sensor automatically returns to its original position for thereby achieving an easier use of the system.

It is possible to perform a measurement multiple times with one time installation in the conventional display appliance, so that it is possible to repeatedly use the same.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. An automatic transportation device of a measurement sensor of a characteristic value of a display appliance, comprising:
a measurement sensor which is positioned on a screen of a display appliance and measures a characteristic value of a display appliance;
a transportation unit which transports the measurement sensor to a center portion of the screen when a characteristic value of the display appliance is measured and transports the same to one side of the display appliance when a measurement of a characteristic value of the display appliance is finished;
a driving force unit which includes a spur gear engaged with the transportation unit and a driving motor connected with the spur gear; and
a control unit which allows the measurement sensor to move to the center of the screen with the help of the transportation unit by operating the driving unit and allows the same to move to its original position when a measurement of a characteristic value of a display appliance is finished.

2. The device of claim 1, wherein said transportation unit comprises:
a first guide bracket which includes a first transportation piece having a first transportation groove in which a rack gear engaged with the spur gear is longitudinally formed on one inner surface of the same, and a first engaging piece which is extended from the first transportation piece, with one end of the same being bent toward the screen;
a second guide bracket which slide-contacts with the first guide bracket and includes a second transportation piece having a second transportation groove in which a rack gear engaged with the spur gear of the motor is formed at a portion opposite to the position of the rack gear of the first transportation groove, and a second guide bracket which includes a second engaging piece extended from the second transportation piece, with one end of the same being bent toward the screen; and
first and second rotation brackets used for fixing the measurement sensor, with one end of each of the same being rotatably engaged with the first and second engaging pieces, respectively, with the other end of each of the same being rotatably engaged with each other.

3. The device of claim 2, wherein said transportation unit further comprises:
a first cover bracket which includes a longitudinal first guide groove for slide-engaging a protrusion protruded from the first transportation piece and is engaged at an outer portion of the first guide bracket;
a second cover bracket which is engaged with the first cover bracket at an outer portion of the second guide bracket and includes a second guide groove for slide-engaging a protrusion from the second transportation piece, whereby the second cover bracket is fixed at the first cover bracket.

4. The device of claim 3, further comprising:
a pad bracket which is provided between the first guide bracket and the first cover bracket or between the second guide bracket and the second cover bracket, with a support piece bent toward the screen being provided between the first and second engaging pieces and the screen so that the first and second engaging pieces are spaced-apart from the screen and slide.

5. The device of claim 2, wherein the engaged portions of the first and second rotation brackets are rotatably engaged on a first engaged surface extended from a longitudinal end of the first rotation bracket in a direction of the first guide bracket and on a second engaging surface bent from a longitudinal end of the second rotation bracket along the first engaging surface, and the measurement sensor is engaged at a longitudinal end of the first rotation bracket.

6. The device of claim 3, wherein a position detection sensor is provided at the first cover bracket or the second cover bracket for detecting a slide-transported position of the first transportation piece or the second transportation piece, with the position detection sensor being engaged at one side of the first guide groove or the second guide groove.

7. The device of claim 1, wherein said main bracket for fixing the driving force is unit comprises:
a driving force transmission body which includes a worm gear engaged with a spur gear of the driving force unit, a first main pulley engaged with the worm gear, a second main pulley connected with the worm gear with a direction adjusting gear being disposed between the same so that it rotates in a direction reverse to the rotation direction of the first main pulley, and an auxiliary pulley which is spaced apart from the first and second main pulleys, respectively;
first and second belts which are parallel with respect to the opposite both surfaces of the main bracket, with one end of each of the same being connected with the first and second main pulleys, respectively, with the other end of each of the same being connected with the first and second driven pulleys, respectively; and
a transportation bracket which includes a front piece engaged with the measurement sensor, a side piece which is bent and extended from both longitudinal ends of the front piece and covers the side of the screen and the main bracket, and a rear piece which is bent and extended from the side piece and is connected with the first and second belts, respectively.

8. The device of claim 7, wherein said outer portions of the first and second belts are connected with the first and second auxiliary pulleys which are spaced apart from the first and second driven pulleys, respectively, in parallel with respect to one side surface of the main bracket.

9. The device of claim 8, wherein the inner sides of the first and second belts are connected with the third and fourth pulleys, respectively, which are installed at inner sides as compared to the first and second pulleys.

10. The device of claim 7, wherein gear teeth are formed on the first and second main pulleys or the first and second driven pulleys or the first through fourth auxiliary pulleys, respectively, and teeth are formed at the inner sides of the first and second belts and are engaged with the gear teeth.

11. The device of claim 7, wherein said first and second belts are made of steel wires.

12. The device of claim 7, wherein said main bracket comprises a position detection sensor for detecting the position of the rear piece.

13. A display appliance having an automatic transportation device of a measurement sensor of a characteristic value of a display appliance, comprising:
an improved automatic transportation device of a measurement sensor of a characteristic value of a display appliance of claim 7, wherein a rim formed at an edge of a screen slides, and a space groove is formed and spaced apart from the screen for thereby accommodating the transportation bracket at one side.

14. A transportation method of a measurement sensor using an automatic transportation device of a measurement sensor of a characteristic value of a display appliance which includes a measurement sensor, a transportation unit, a driving force unit and a control unit, comprising:
a transportation step in which the driving force unit operates in accordance with a user's measurement start instruction, and the measurement sensor is transported near a center of the screen of the display appliance;
a correction step in which a characteristic value of the display appliance is measured with the help of the measurement sensor, and the screen is adjusted by using the measured characteristic value of the display appliance; and
a return step in which the measurement sensor returns to its original position by operating the driving force unit after the screen adjustment is finished.

15. The method of claim 14, wherein in said transportation step or said return step, the measurement sensor is transported near a center of the screen or returns to its original position by rotating the motor engaged at the driving force unit by a previously set revolution.

16. The method of claim 14, wherein in said transportation step or said return step, the control unit detects a rotation load occurring in the motor of the driving force unit depending on a displacement limit of the transportation unit and disconnects the power of the driving force unit.

17. The method of claim 14, wherein in said transportation step or said return step, the power of the driving force unit is disconnected as the control unit receives a signal from the position detection sensor engaged in the transportation unit.
